(19) United States
(12) Patent Application Publication
(10) Pub. No.: US 2019/0044347 A1
(43) Pub. Date: Feb. 7, 2019

(54) MULTIPLE OUTPUT BATTERY SYSTEM

(71) Applicant: Jaguar Land Rover Limited, Coventry (GB)

(72) Inventor: Mike RICHARDSON, Coventry (GB)

(21) Appl. No.: 16/042,821

(22) Filed: Jul. 23, 2018

(30) Foreign Application Priority Data
Aug. 1, 2017 (GB) 1712330.8

(51) Int. Cl. H02J 7/00; H02J 7/04; B60L 11/18

(52) U.S. Cl. CPC H02J 7/0014; H02J 7/045; B60L 11/1866; B60L 11/1861; H02J 7/0021

(57) ABSTRACT

A battery system comprising: a battery having a first leg connected in series with a second leg; and an energy balancing device; wherein: the energy balancing device is arranged to: monitor one or more properties of the first leg and/or second leg; and control the transfer of charge between the first leg and the second leg, thereby to adjust the level of charge of each of the first leg and the second leg based on the one or more monitored properties of the first leg and/or second leg.

### CROSS-REFERENCE TO RELATED APPLICATION

This application claims priority under 35 U.S.C. § 119 to Great Britain Application No. 1712330.8, filed Aug. 1, 2017, the content of which is incorporated herein by reference in its entirety.

### TECHNICAL FIELD

The present disclosure relates to a multiple output battery system. Particularly, but not exclusively, the disclosure relates to a multiple output battery system for a vehicle. Aspects of the invention relate to a battery system, a method of adjusting the state of charge in a battery system and a vehicle comprising a battery system.

### BACKGROUND

There is an urgent need to optimise battery provisions for use in vehicles, such as hybrid electric vehicles. Hybrid electric vehicles use electric power to supplement traditional engines, such as internal combustion engines, in order to provide more efficient drive systems with reduced CO₂ emission.

It is known to provide hybrid electric vehicles that use two voltage sources in order to service different loads in a vehicle. A 12 V voltage supply is typically required to provide power for a significant proportion of the electrically operated functions of a vehicle (e.g., engine starting, lighting, air conditioning, consumer electronics, etc., which may or may not require further voltage manipulation via systems such as voltage converters). In addition, 48 V voltage supplies are becoming more frequently used to provide increased power for engine-support functions and other high energy consuming features and systems. Accordingly, known systems that require two voltage sources use two separate batteries: a 12 V battery and a 48 V battery.

In order to maintain the working function of these separate batteries, following discharge to provide their dedicated functions, the separate batteries must be recharged in order to replenish their stored electrical energy. Typically, 48 V batteries are in electrical communication with a belt starter generator/motor. Consequently, via an inverter, the 48 V battery can be used to supply the necessary power to operate a motor, as well as to be recharged by the generator. The 48 V battery is then connected in parallel to a 12 V battery via a DC to DC converter, which enables the 12 V battery to be charged. The 12 V battery is connected to the loads that it is used to service.

Whilst the use of 48 V power sources has associated benefits in respect of the ability to support high power systems and to reduce environment impact, the use of an additional power source also affects the cost and the required packaging volume and weight of the additional components. It is an aim of the present invention to mitigate at least some of the disadvantages associated with known systems.

### SUMMARY OF THE INVENTION

Aspects and embodiments of the invention provide a battery system, a method of adjusting the state of charge in a battery system and a vehicle comprising a battery system as claimed in the appended claims.

According to an aspect of the invention, there is provided a battery system comprising: a battery having a first leg connected in series with a second leg; and an energy balancing device; wherein: the energy balancing device is arranged to: monitor one or more properties of the first leg and/or second leg; and control the transfer of charge between the first leg and the second leg, thereby to adjust the level of charge of each of the first leg and the second leg based on the one or more monitored properties of the first leg and/or second leg. Advantageously, the battery provides a single battery that can intelligently redistribute the apportionment of charge between different battery legs with different nominal voltages and capacities.

According to an aspect of the invention, there is provided a battery system comprising: a battery having a first leg connected in series with a second leg; energy balancing means for monitoring one or more properties of the first leg and/or second leg, the energy balancing means configured to adjust the level of charge of each of the first leg and the second leg based on the one or more monitored properties.

According to an aspect of the invention, there is provided a battery system as described above, wherein: said energy balancing means for monitoring one or more properties of the first leg and/or second leg comprises an electronic processor having an electrical input for receiving one or more signals each indicative of the one or more monitored properties, an electronic memory device electrically coupled to the electronic processor and having instructions stored therein, said energy balancing means monitoring one or more properties comprises the processor being configured to access the memory device and execute the instructions stored therein such that it is operable to detect that charge is to be transferred between the first leg and the second leg and commanding the energy balancing means to transfer charge between the first leg and the second leg.

Optionally, the energy balancing means comprises voltage converting. Optionally, the voltage converting means is configured to convert the voltage of the first leg substantially to the voltage of the second leg, thereby to enable transfer of charge from the first leg to the second leg. Further, optionally, the voltage converting means is configured to convert the voltage of the second leg substantially to the voltage of the first leg, thereby to enable transfer of charge from the second leg to the first leg. Beneficially, the use of a single voltage converting means enables switching between up-conversion as well as down-conversion and therefore the battery system provides a simple and elegant mechanism for efficiently converting voltages in order to enable the redistribution of charge in a battery.

In an embodiment if the level of charge of the first leg is above a threshold level of charge of the first leg and the level of charge of the second leg is below a threshold level of charge of the second leg, the energy balancing means is arranged to adjust the level of charge of the battery by transferring stored energy from the first leg to the second leg. Optionally, the threshold level of charge of the first leg represents a substantially fully charged first leg and/or wherein the threshold level of charge of the second leg represents a substantially fully charged second leg. Advantageously, the battery provides a single battery that can intelligently redistribute the apportionment of charge between different battery legs with different nominal voltages and capacities.

In an embodiment, if the level of charge of the second leg is above a threshold level of charge and the second leg and the level of charge of the first leg is below a threshold level of charge of the first leg, the energy balancing means is arranged to adjust the level of charge of the battery by transferring stored energy from the second leg to the first leg. Optionally, the threshold level of charge of the first leg represents a substantially fully charged first leg and/or wherein the threshold level of charge of the second leg represents a substantially fully charged second leg. Advantageously, the battery provides a single battery that can intelligently redistribute the apportionment of charge between different battery legs with different nominal voltages and capacities.

In an embodiment, the energy balancing means comprises: a switching means; and an inducting means, wherein the switching means and the inducting means are in electrical communication with the first leg and the second leg, and wherein the energy balancing means is arranged to control the transfer of charge between the first leg and the second leg by operating the switching means so as to control the flow of current through the inducting means. Optionally, the inducting means is arranged electrically to connect to a common terminal of the first leg and of the second leg, and wherein the switching means is arranged electrically selectively to connect the positive terminal of the battery with the inducting means. Optionally, in a pulse width modulated signal is applied to the switching means. Further, optionally, energy balancing means comprises a circuit blocking means arranged to prevent flow of current from the switching means to the negative terminal of the battery. Further, the energy balancing means may comprise a further switching means in electrical communication with the first leg and the second leg, wherein the energy balancing means is arranged to control the transfer of charge between the first leg and the second leg by operating both the switching means and the further switching means so as to control the flow of current through the inducting means. Optionally, the switching means and/or further switching means are in parallel with circuit blocking means. The pulse width modulated signals may be applied to the switching means and the further switching means.

In an embodiment, the first leg is configured to supply a first voltage and the second leg is configured to supply a second voltage and wherein the first voltage is different from the second voltage. Optionally, the first voltage is higher than the second voltage.

In an embodiment, the first leg has a first energy storage capacity and the second leg has a second energy storage capacity, wherein the first energy storage capacity is different from the second energy storage capacity. Optionally, the first energy storage capacity is less than the second energy storage capacity.

In an embodiment the battery system is arranged selectively to receive power from a power source, thereby to recharge the first leg and/or the second leg.

In an embodiment, the first leg is a 36 V battery and/or the second leg is a 12 V battery. Advantageously, compared with a standard 48 V battery, the high capacity 12 V battery is large and therefore heat dissipation is low and the battery system 100, 200 is simpler to cool than known systems. 12 V batteries are not subject to the same level heating as a standalone 48 V battery. Further, the efficient integration of a 12 V battery in series with a 36 V battery means that the battery system 100, 200 will have reduced weight and package volume than known systems that have separate 48 V and 12 V batteries that are typically required in hybrid electric vehicles.

In an embodiment, the battery system is in communication with a motor and/or a generator. In an embodiment, the battery system is configured to drive a starter motor. In an embodiment, the first leg and the second leg are integrated into a single unit. In an embodiment, the one or more properties comprises level of charge or load.

According to another aspect of the invention, there is provided a method of adjusting the state of charge in a battery system comprising a battery having a first leg connected in series with a second leg, the method comprising: monitoring one or more properties of the first leg and/or second leg; and in dependence on the one or more monitored properties: controlling the transfer of charge between the first leg and the second leg, thereby to adjust the state of charge of each of the first leg and the second leg.

According to yet another aspect of the invention, there is provided a vehicle comprising a battery system comprising: a battery having a first leg connected in series with a second leg; and an energy balancing means; wherein: the energy balancing means is arranged to: monitor one or more properties of the first leg and/or second leg; and control the transfer of charge between the first leg and the second leg, thereby to adjust the level of charge of each of the first leg and the second leg based on the one or more monitored properties of the first leg and/or second leg. Optionally, the vehicle is a hybrid electric vehicle. Beneficially, the battery system can be integrated into vehicles, such as hybrid electric vehicles. The battery system provides electric sources to service loads of different voltages. Advantageously, the battery system provides loads at 12 V and 48 V, providing drive support along for a hybrid electric vehicle, along with the power to service the numerous electric systems found in a vehicle.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic of a battery system including a controller;

FIG. 2A is a table of operational states of a battery system;

FIG. 2B is a table of operational states of a battery system;

FIG. 3A is a schematic of a battery system;

FIG. 3B is an equivalent simplified diagram of the battery system of FIG. 3A;

FIG. 3C is an equivalent simplified diagram of the battery system of FIG. 3A;

FIG. 3D is an equivalent simplified diagram of the battery system of FIG. 3A;

FIG. 4A is a schematic of a battery system;

FIG. 4B is an equivalent simplified diagram of the battery system of FIG. 4A;

FIG. 4C is an equivalent simplified diagram of the battery system of FIG. 4A;

FIG. 4D is an equivalent simplified diagram of the battery system of FIG. 4A;

FIG. 4E is an equivalent simplified diagram of the battery system of FIG. 4A;

FIG. 4F is an equivalent simplified diagram of the battery system of FIG. 4A; and

FIG. 5 is a schematic of a vehicle having a battery system.

### DETAILED DESCRIPTION

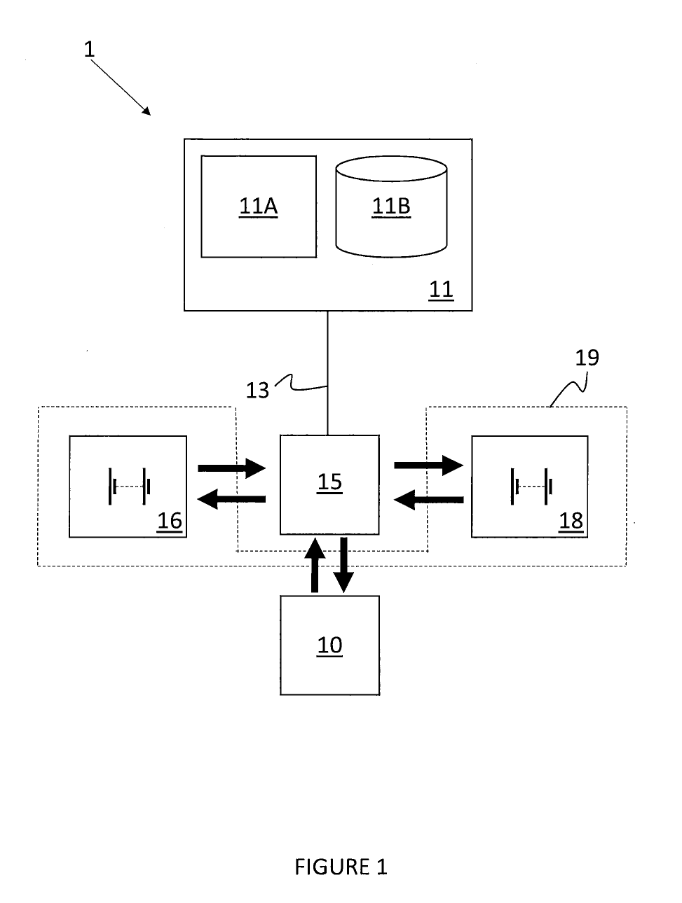

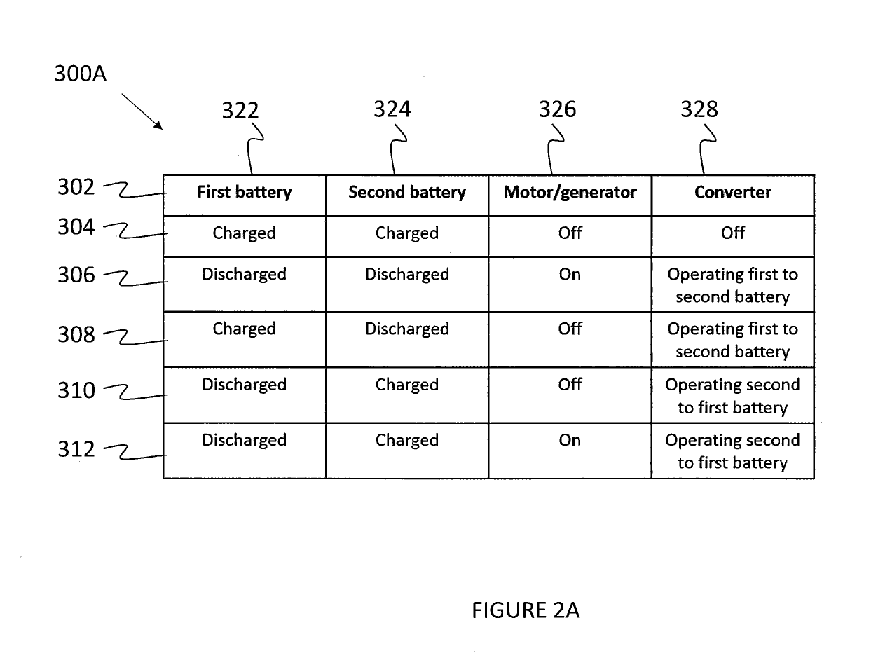

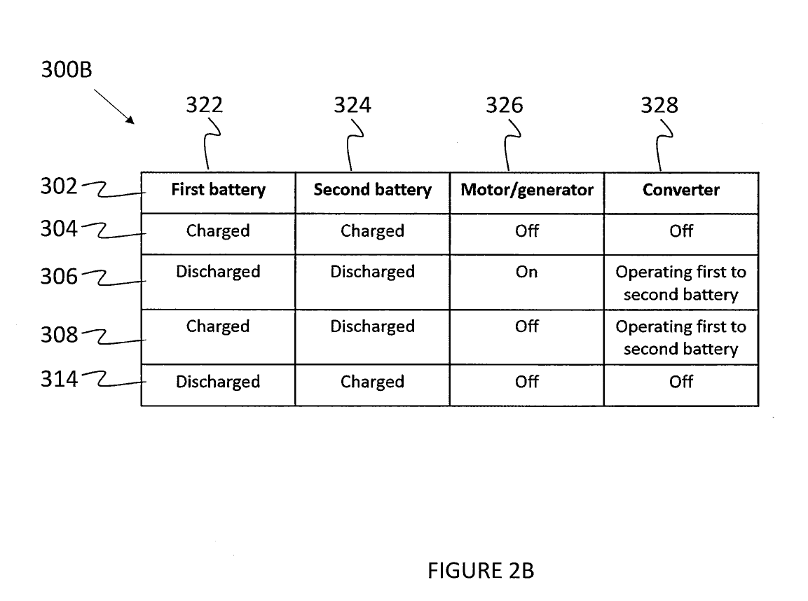

FIG. 1 is a schematic of a battery system 1 including a controller 11. The battery system 1 is described below in more detail, with reference to FIGS. 2 to 5. There is shown, at FIG. 1, a controller 11 that is in electrical communication with an energy balancing device 15 via communication path 13. The energy balancing device 15 is arranged to transfer charge between a first battery leg 16 and a second battery leg 18 that are connected together in series to form a battery 19 that is part of a battery system 1. There is also a motor/generator 10 that is arranged to supply power that is used to charge the first battery leg 16 and the second battery leg 18 of battery 19, and that can also be powered by the battery 19. The battery system 1 is described in more detail, below, with reference to FIGS. 2A to 2B, FIGS. 3A to 3D and FIGS. 4A to 4F.

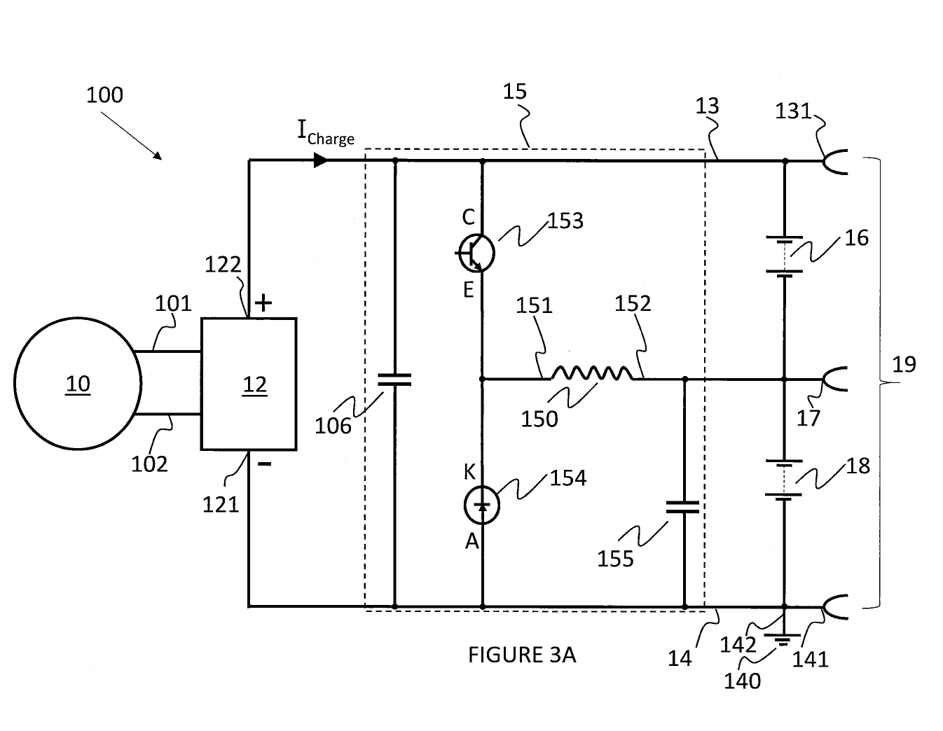

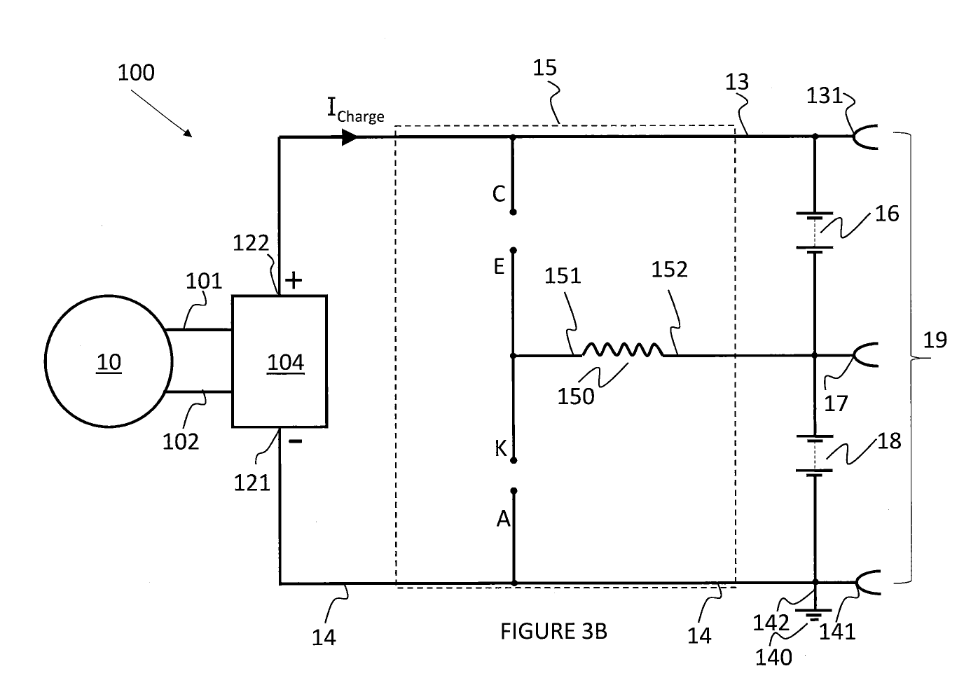

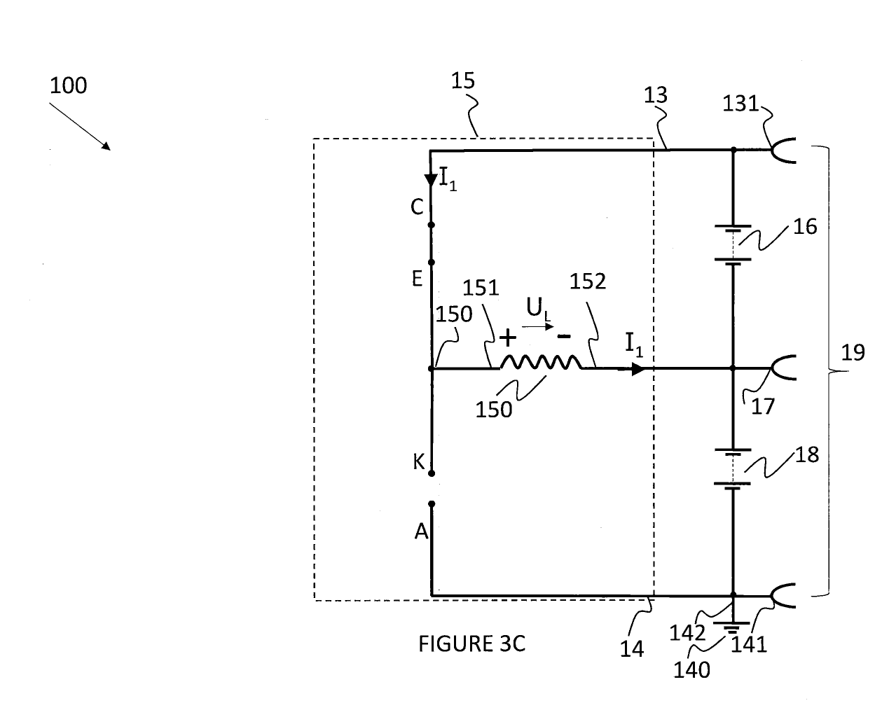

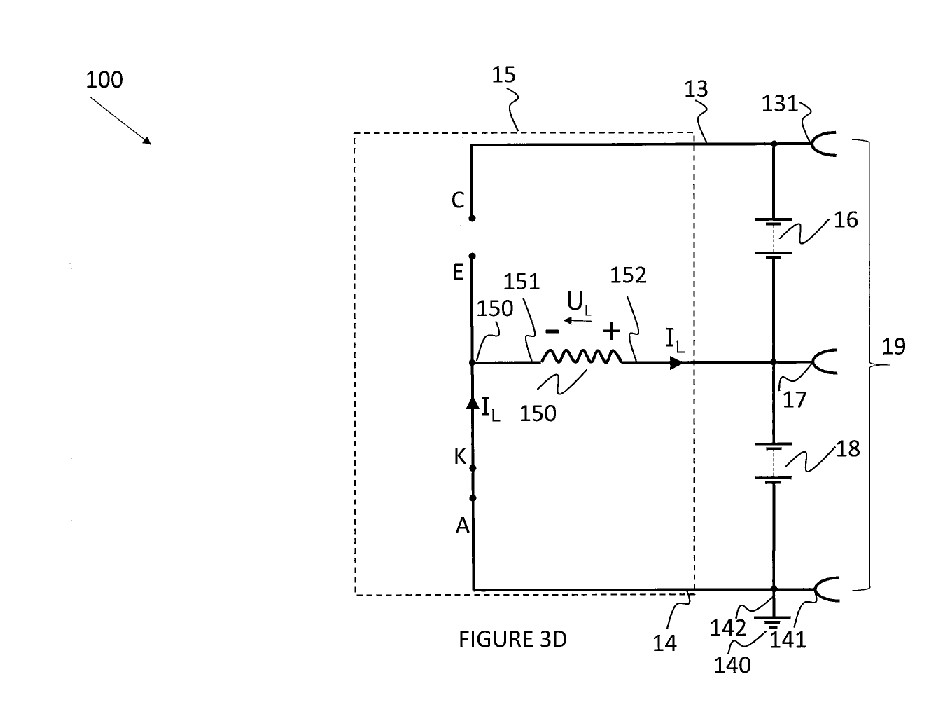

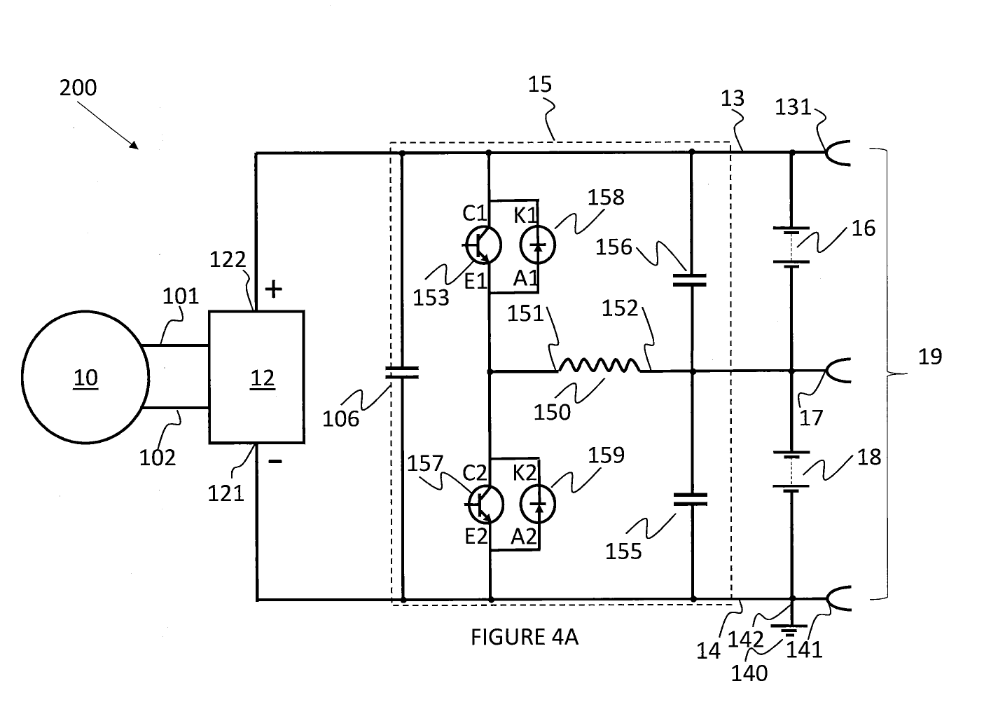

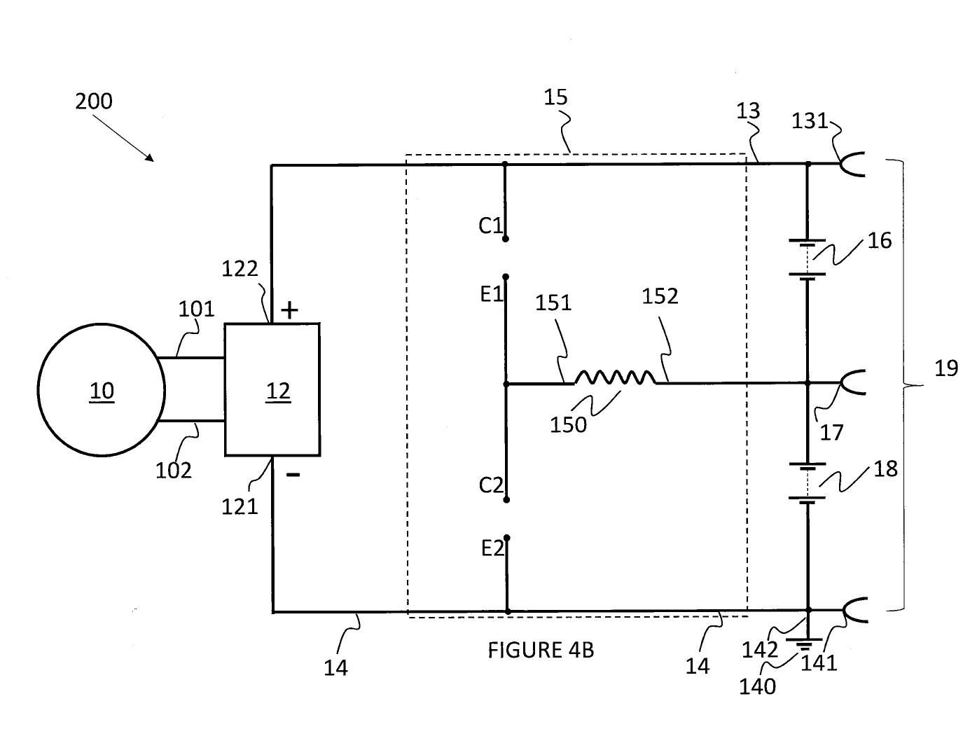

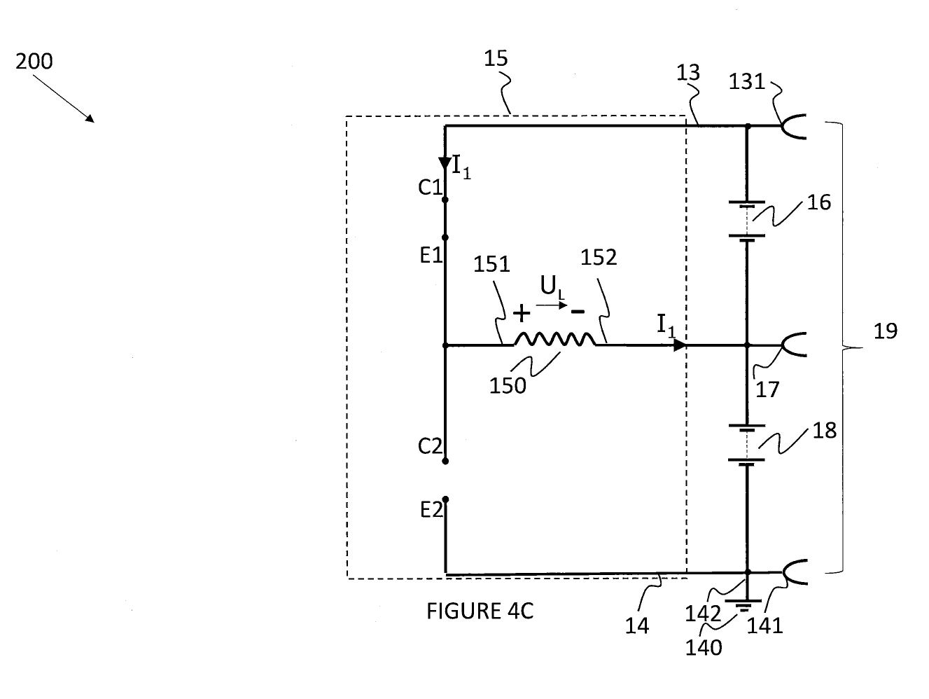

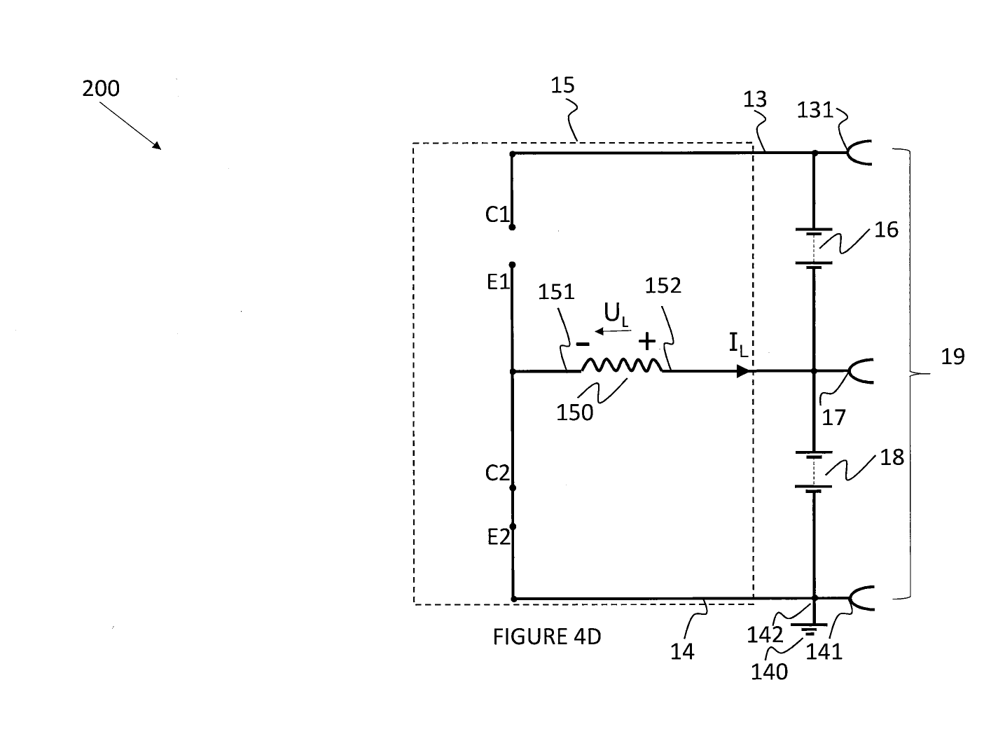

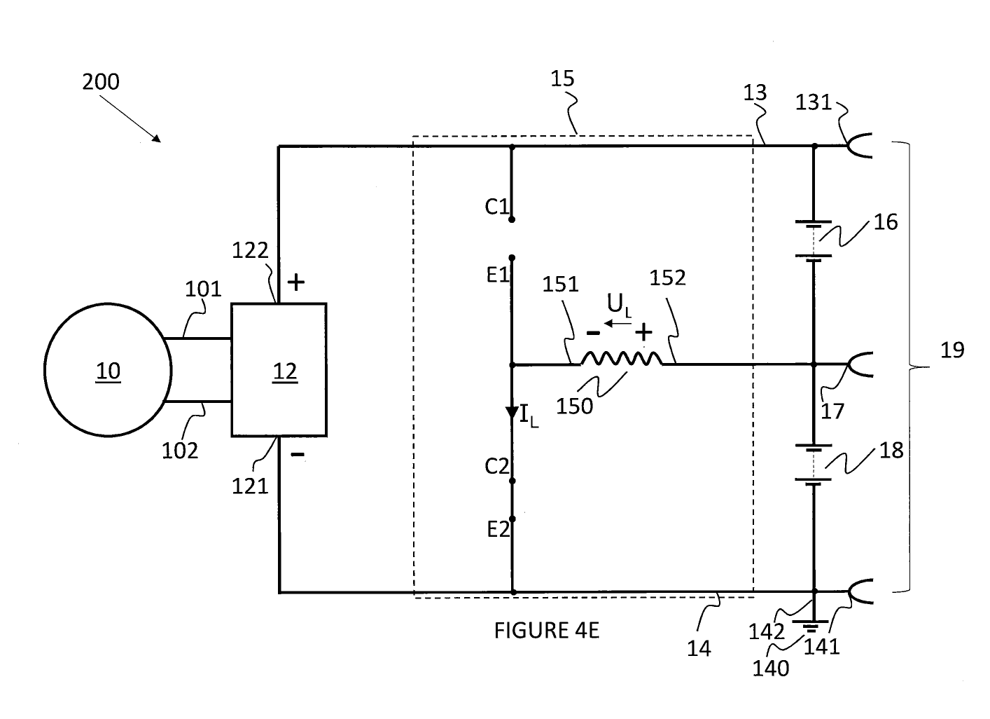

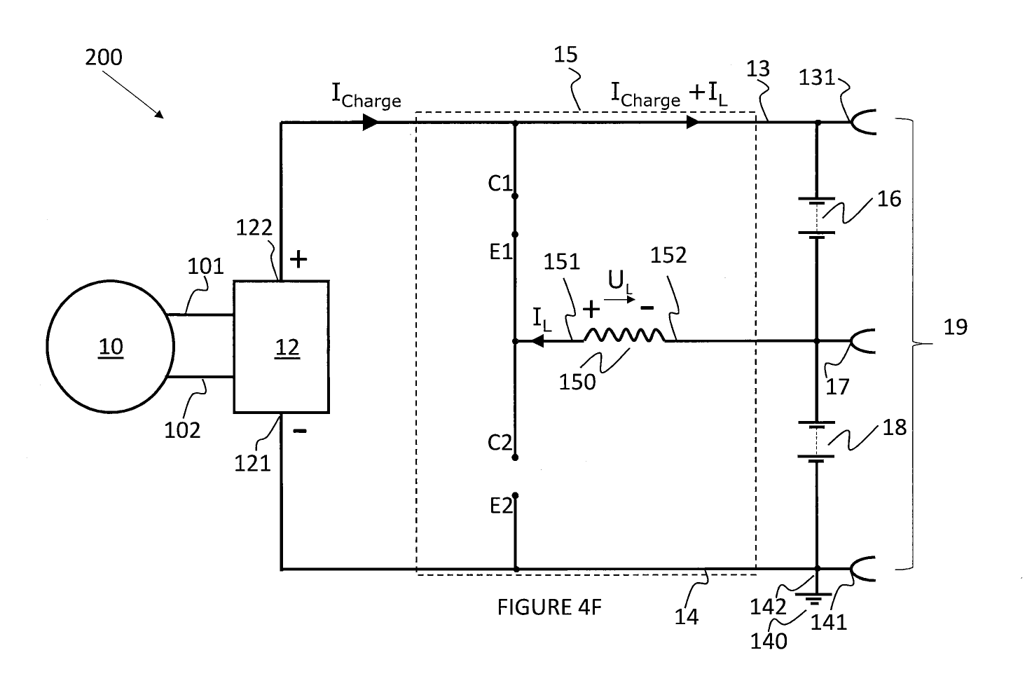

The controller 11 of FIG. 1 has a processor 11A and a memory 11B and is in communication with an energy balancing device 15. The energy balancing device 15 is part of a battery system, such as the battery systems 100, 200 described with reference to FIGS. 3A to 3D and 4A to 4F. The controller 11 monitors the battery legs 16, 18 of the battery system (e.g., the battery system 100, 200) and provides feedback control as part of a energy balancing device 15 of the battery systems 100, 200, thereby to adjust the level of charge between battery legs 16, 18 of the battery 19 of the battery system 100, 200 and hence optimise the level of charge distribution within the battery 19. The energy balancing device 15 is therefore used to shuttle energy between the battery legs 16, 18 of the battery 19.

Table 300A of FIG. 2A shows five scenarios for the operation of a battery system, such as the battery system 1 described above with reference to FIG. 1. These operational states are shown at rows 304, 306, 308, 310 and 312 of Table 300A. Each operational state 304, 306, 308, 310 and 312 is described using four descriptors at columns 322, 324, 326 and 328. Accordingly, the first row 302 of table 300A is a row of headers including the state of charge of the first battery leg 16 at the first column 322, the state of charge of the second battery leg 18 at the second column 324, the state of the motor/generator at the third column 326 and the state of the energy balancing device 15 at the fourth column 328 (this is also referred to as the ‘converter’).

As seen at the second row 304 of table 300A, when the first battery leg 16 and the second battery leg 18 are both fully charged (that is to say that their respective states of charge are approximately at capacity), the motor/generator 10 is switched off, as no power is required to charge any element of the battery 19 (e.g., the first battery leg 16 or the second battery leg 18). A battery leg may be considered to be fully charged if the level of charge is above a threshold. If the level of charge is below a threshold, the battery may be considered discharged. The energy balancing device 15 does not need to redirect any energy and is in an ‘off’ configuration. Therefore a converter of the energy balancing device 15 is considered to be off. Circuits that are used to provide this functionality are shown at FIGS. 3 and 4 below. In particular, FIG. 3B and FIG. 4B show equivalent simplified diagrams that illustrate the situation of the row 304 of table 300A.

As shown at the third row 306 of table 300A of FIG. 2A, when both the first battery leg 16 and the second battery leg 18 of the battery 19 are discharged, the motor/generator 10 is used to supply power to the battery 19. Due to the connection of the motor/generator power source 10 to the battery 19 at the positive terminal of the battery 19 and the negative terminal of the battery 19, charge flows through the battery system so as to charge both the first battery leg 16 and the second battery leg 18. Circuits that are used to provide this functionality are shown at FIGS. 3 and 4 below. In particular, this configuration is also shown at FIG. 3B and FIG. 4B, where the simplified equivalent diagrams illustrate the connection between a converter 12 and the battery 19.

In use, when the battery 19 is charged from a power source, such as the motor/generator 10, if the capacity of the first battery leg 16 is smaller than that of the second battery leg 18, the first battery leg 16 will surpass a charge level threshold indicating that the first battery leg 16 is fully charged before the second battery leg 18 surpasses a charge level threshold indicating that the 12 V battery leg 118 is fully charged. In this situation, the first battery leg 16 is said to be fully charged (or ‘charged’) and the second battery leg 18 is said to be discharged (which indicates any state of charge level below a predetermined threshold). The battery system 1 is configured to react to this situation as described at the fourth row 308 of table 300A of FIG. 2A.

As seen at the fourth row 308 of table 300A of FIG. 2A, when the first leg 16 of the battery 19 is fully charged, but the second 18 of the battery 19 is not fully charged, the motor/generator 10 is switched off and the energy balancing device 15 is used to direct energy from the first leg 16 to the second leg 18. The converter is said to be ‘on’, as noted at the fourth column 328, fourth row 308 of table 300A. Circuits that are used to provide this functionality are shown at FIGS. 3 and 4 below. In particular, the transfer of charge from the first battery leg 16 to the second battery leg 18 is illustrated at FIGS. 3C and 3D and FIGS. 4C and 4D.

As shown at the fifth 310 and sixth 312 rows of the table 300A of FIG. 2A when the first battery leg 16 of the battery 19 is discharged (e.g., less than a charge level threshold of the second battery leg 16) and the second battery leg 18 of the battery 19 is charged (e.g., greater than a charge level threshold of the second battery leg 18), the energy balancing device 15 is arranged to transfer charge from the second battery leg 18 to the first battery leg 16. As shown at row 310 of table 300A, the transfer of charge from the second battery leg 18 to the first battery leg 16 can be implemented when the motor/generator 10 is off. Alternatively, as shown at row 312 of table 300A, the transfer of charge from the second battery leg 18 to the first battery leg 16 can be implemented when the motor/generator 10 is on. This enables charge to be transferred from a higher capacity, lower voltage battery leg to a lower capacity, higher voltage battery leg, for example. FIG. 4 illustrates a circuit that can be used to implement this functionality. In particular, FIGS. 4E and 4F show equivalent simplified diagrams of FIG. 4A that illustrate the operation of the states shown at rows 310, 312 of table 300A. Note that a higher voltage generator can be connected across the batteries in series or a lower voltage generator can be connected across the lower voltage leg of the battery. The principle of operation remains the same.

The operational states of rows 304, 306, 308, 310, 312 of table 300A of FIG. 2A can be implemented by the embodiment described with respect to FIGS. 4A to 4F, below. The operational states of rows 304, 306, 308 can also be implemented by the embodiment described with respect to FIGS. 3A to 3D, below.

FIG. 2B shows a table 300B of alternative operational states. The first three rows of operational states 304, 306, 308 are the same as the operational states described at the first three scenarios at rows 304, 306, 308 of table 300A of FIG. 2A. However, as shown at the fifth row 314 of the table 300B of FIG. 2B, when the first leg 16 of the battery 19 is discharged (e.g., less than a charge level threshold of the first battery leg 16) and the second battery leg 18 of the battery 19 is charged (e.g., greater than a charge level threshold of the second battery leg 18), the motor/generator 10 is not configured to charge the battery 19 and the energy balancing device does not redistribute stored electrical energy in the battery system 1. In an example where the first battery leg is a 36 V battery connected in series with a second battery leg that is a 12 V leg, the battery system is able to supply a 48 V load. Typically, the use of a 48 V load is less than that of a 12 V load, therefore there may be no need to charge up the 36 V battery leg 16 when the 12 V battery leg 18 is fully charged. This functionality can be provided by the embodiment of the invention described in relation to FIGS. 3A to 3D, below.

FIG. 3A is a schematic of a battery system 100 with a battery 19 comprising a first leg 16 and a second leg 18. The first leg and the second leg may consist of identical batteries, or batteries with the same nominal voltage but different capacities. In the following embodiments however, the first leg is a high voltage battery 16 and the second leg is a low voltage battery 18 which form, together, a battery arrangement 19. This terminology will be used here. The person skilled in the art however will readily appreciate that the order in which the batteries are connected or their nominal output voltage, or their capacity makes no difference to the principle and teaching of the present invention.

The high voltage battery 16 is electrically connected with its negative pole to the positive pole of the low voltage battery 18. In the embodiments of FIGS. 3 and 4, the high voltage battery 16 has a nominal voltage of 36 Volts and the low voltage battery 18 has a nominal voltage of 12 Volts. The high voltage battery 16 is formed from cells in a 10S1P configuration and has a capacity of 8 Ah. The low voltage battery 18 is formed of cells in a 4S3P configuration has a capacity of 120 Ah. The negative pole of the 12V battery defines a common ground for all electrical consumers in a car and is connected to a common ground rail 14. The common ground rail 14 is electrically conductively connected to vehicle earth 140 via an earthing strap 142 and provides common ground also on a common ground terminal 141. The positive pole of the 12V battery 18 is electrically conductively connected to a 12V terminal 17 for supplying consumers designed for a nominal voltage of 12V in the car. The positive pole of the 36V battery 16 is electrically conductively connected to a high voltage rail 13, which provides a high voltage power supply at a high voltage terminal 131. As the negative pole of the 36V battery 16 is electrically conductively connected to the positive pole of the 12V battery, the voltage between the common ground terminal 141 and the high voltage terminal 131 is the sum of the voltage of the low voltage battery 18 and the high voltage battery 16, which in this embodiment adds up to 48 volts. Consumers designed for a nominal voltage of 48V will be connected to the common ground rail 14 or vehicle earth 140 and the high voltage terminal 131.

A motor/generator 10 is in communication with an inverter 12 via power lines 101, 102. The negative output terminal 121 of the inverter 12 is connected to the common ground rail 14. The positive power output terminal 122 of the inverter 12 is connectively conductively connected to a high voltage rail 13. A first capacitor 106 across the negative power output terminal 121 of the converter 12 and the positive output terminal 122 of the converter 12 smoothens the output voltage of the inverter 12. The inverter 12 is designed to provide a charging current I_{charge} for the battery arrangement 19. In order to charge the battery arrangement 19 the output voltage of the inverter 12 must be higher than the actual voltage of the battery arrangement 19. The inverter 12 may provide a current limitation to prevent the battery arrangement 19 from overloading.

When neither the low voltage battery 18, nor the high voltage battery 16 is fully charged, the inverter 12 will provide for a charging current I_{charge} that flows successively from high voltage rail 13 through high voltage battery 16 and the low voltage battery 18 back to common ground rail 14. With regard to the higher capacity of the low voltage battery 16 compared to the lower capacity of the high voltage battery 18, under normal circumstances the high voltage battery 16 will be fully charged before the low voltage battery 18 reaches full charging level. In case the inverter 12 continues to charge both batteries 16, 18, the battery that was fully charged first may be damaged due to overcharging. Assuming that the high voltage battery 16 is always fully charged before the low voltage battery 18 is fully charged, for such an embodiment it is sufficient to provide an energy balancing device 15 that shifts charges from the high voltage battery 16 to the low voltage battery 18 once the high voltage battery 16 is sufficiently fully charged whilst the low voltage battery 18 still needs charging.

Therefore, the energy balancing device 15 of this embodiment of the present invention allows for transferring the charge current provided for the battery arrangement 19 of the low voltage battery 18 and the high voltage battery 16 to be transferred into a charging current that primarily flows only through the low voltage battery 18. This mode will be called in the following: ‘down charge’ mode. In down charge mode, a charge balancing controller 11, referred to in the following in a shortened form just as a ‘controller’ 11, monitors the charging levels of each of the high voltage battery 16 and the low voltage battery 18. In the case that the controller 11 detects that the charging level of the high voltage battery 16 is substantially full and the charging level of the low voltage battery 18 indicates that it still needs further charging, the controller 11 activates an energy balancing device 15.

The energy balancing device 15 of this embodiment comprises an inductor 150, a transistor 153, a diode 154 and a second capacitor 155. In order to transfer the charge current I_{charge} provided on the high voltage rail 13 to the low voltage battery 18 in an efficient way, i.e. without too much power loss, the transistor 153 is conductively connected with its collector C to the high power rail 13 and with its emitter E to a first terminal 151 of the inductor 150. A second terminal 152 of the inductor 150 is connected to the positive pole of the low voltage battery 18. As this second terminal 152 of the inductor 150 is electrically fixed to the voltage potential of the positive pole of the low voltage battery 18, this second terminal 152 of the inductor 150 is termed in the following as the ‘fixed terminal’ 152 of the inductor 150. As the voltage at the first terminal 151 of the inductor 150 is floating with the self-induced voltage of the inductor 150, this first terminal 151 of the inductor 150 is termed in the following as the ‘floating terminal’ 151 of the inductor 150. The diode 154 is connected with its cathode K to the floating terminal 151 and with its anode A to the common ground rail 14. The second capacitor 155 is also used as a smoothing capacitor for smoothing current ripples which may occur at the fixed terminal 152. Here fore, one terminal of the second capacitor 155 is electrically conductively connected to the fixed terminal 152 and the other terminal of the second capacitor 155 is connected to the common ground rail 14.

In order to demonstrate how the charges are transferred from the high voltage battery 16 to the low voltage battery 18, FIGS. 3B, 3C and 3D show the components of the energy balancing device 15 of FIG. 3A in an equivalent simplified diagram which shows primarily only the components if they are in a conductive state or otherwise contributing to the function of the charge transfer. Electrical components which have no influence in a certain phase of the charge transfer process have been fully faded out for a better understanding of the principles of the charge transfer process. When the controller 11 generates no control signal for a longer time, the energy balancing device 15 is set in a static, deactivated state as represented by FIG. 3B. In a dynamic state the controller 11 generates a pulse width modulated control signal for controlling the switching state of transistor 153. The pulse width modulated signal sets the energy balancing device 15 in a dynamic state as the energy balancing device 15 cycles through a switch-on state symbolized in FIG. 3C to a switch off state, symbolized in FIG. 3D, and from the dynamic switch off state back to the switch on state represented in FIG. 3C to start a new cycle.

The energy balancing device 15 of the battery system 100 has a number of components 153, 150, 154, 155. The transistor 153 is connected to a control unit (not shown in FIG. 3, but may be the controller 11 of FIG. 1, and may be integrated with the battery system 100). The energy balancing device 15 is controlled by a controller, such as the controller 11 described in relation to FIG. 1. The controller 11 activates and deactivates the transistor 153 to act as a switch to control the flow of current through the battery system 100. The controller 11 activates and deactivates the transistor 153 by applying a pulse width modulated signal. When the transistor 153 is switched on, current can flow the collector C and the emitter E. When the transistor 153 is switched off, no current can flow between the collector C and the emitter E.

FIG. 3B shows the circuit in the deactivated state. In the deactivated state the controller 11 provides a control signal at a voltage level which forces the collector-emitter path C-E of the transistor 153 in a non-conductive state. Therefore, the situation is the same as if the transistor 153 were not present at all. This is symbolized in FIG. 3B as an interrupted connection between the symbolized collector terminal C and the symbolized emitter terminal E of transistor 153. The deactivated state is a static state, which means that the control signals are switched off for a longer time period such that the inductor 150 has no magnetic field. In the static state no current is flowing through or induced by the inductor 150 and therefore the voltage potential at the floating terminal 151 of the inductor 150 is the same as at the fixed terminal 152 of the inductor 150 and is the same as the voltage on the positive pole of the low voltage battery 18. This also means that the voltage at the cathode K of the diode 154 is at a higher voltage potential than at the anode A of the diode 154. Thus the diode 154 is biased in a reverse direction and blocks any current flow through the diode 154. This is equivalent to a non-conductive state of the diode 154 and consequently in the equivalent simplified schematic of FIG. 3B the diode 154 has also been faded out and is symbolized by an interrupted connection by its anode A and its cathode K.

As is seen from FIG. 3B, in the static state no current flows neither through the collector-emitter path C-E of transistor 153, nor through the anode-cathode path of diode 154, nor through the inductor 150. As a consequence in the deactivated state of the energy balancing device 15 the charging current I_{charge} provided by the inverter 12 flows only through the high voltage battery 16 and the low voltage battery 18, charging both batteries 16, 18.

FIGS. 3C and 3D are equivalent simplified diagrams of the battery system 100 for the dynamic situation when the controller 11 applies a cyclic pulse width modulated control signal to transistor 153. FIG. 3C shows the part of the cycle when the pulse width modulated control signal sets the transistor 153 into a conductive state. This is symbolised in FIG. 3C by a short circuit of the collector-emitter path C-E between the collector C and the emitter E of transistor 153. As the equivalent simplified diagram of FIG. 3C shows, the transistor 153 in the switched-on state connects the floating terminal 151 of the inductor 150 to the high voltage rail 13. This means that the floating terminal 151 is connected to a voltage of +48V and the fixed terminal 152 of the inductor 150 is connected to a voltage of +12V with respect to common ground 140. Consequently, a current I₁ is flowing through the inductor 150 from the high voltage rail 130 to the negative pole of the high voltage battery 16. The current I₁ flowing through the inductor 150 may be provided by the high voltage battery 16 alone, in the case the converter 12 is switched off, or may be composed by a first current originating from the converter 12 and a second current originating from the high voltage battery 16. The current I₁ flowing through the inductor 150 will build up a magnetic field in its surroundings in which the electric energy of the current I₁ is converted into magnetic energy. Due to the shortcut of the collector-emitter path C-E of transistor 153, the cathode K of the diode 154 is on the voltage potential of the high voltage rail 13 and therefore the diode 154 is still biased in the reverse direction, i.e. in a non-conductive mode. Thus, there is no electrical conductive connection between the floating terminal 151 of the inductor 150 and the common ground rail 14 via diode 154.

FIG. 3D shows the situation when the controller 11 switches off transistor 153, i.e. the collector-emitter path C-E of transistor 153 is in a non-conductive state. This is symbolised in FIG. 3D as an interruption between the collector C and the emitter E of transistor 153. This interruption seizes the current I₁ that is flowing from the high voltage rail 13 through the inductor 150 to the negative pole of high voltage battery 16, and the magnetic field of the inductor 150 collapses. Any changes of current, and therefore in the magnetic flux through the cross-section of the inductor, create an opposing electromotive force in the conductor. According to Lenz's law, which states that an inductor opposes change in current, the collapsing magnetic field induces a voltage U_{L} which is inverse in polarity compared to the voltage across the inductor 150 when the inductor 150 was supplied with current from the high voltage rail 13. As long as the inductor cannot discharge, the voltage of the induced voltage U_{L} will increase immediately and the potential of the floating terminal 151 of the inductor 150 becomes increasingly negative in comparison to the potential of the fixed terminal 152. Once the induced voltage U_{L} surpasses the voltage of low voltage battery 18 and the threshold voltage of diode 154, which in nominal values is a voltage around 12V+0.7 V=12.7V, the diode 154 changes its state into a turned-on state and conducts current from its anode A to its cathode K. This one-way conductive state is symbolised in the simplified schematic of FIG. 3D by a shortcut between the anode A and the cathode K. As a consequence of the self-induction, the inductor 150 now becomes a power source supplying current I_{L} that decreases over time. As long as the magnetic field has not totally collapsed, the current I_{L} created by the self-induction of the inductor 150 will flow from the fixed terminal 152 through the battery 18 back to the floating terminal 151 and by this charging the low voltage battery 18.

After the end of one cycle the controller 11 will finally switch the transistor 153 back to ‘on’ and the cycle starts again, as depicted in FIG. 3C, by building up the magnetic field in the inductor 150. Ideally, the switching frequency of the control signal for the transistor 153 is chosen to be high enough that, for a given inductivity L of the inductor 150, the magnetic field never completely collapses and the charging current I_{L} is maintained throughout the switched off period of the switching cycle. The duty cycle of the control signal, i.e. the time the transistor 153 is switched on in relation to the total time of the transistor 153 being switched on and being switched off allows to optimise the efficiency of the power conversion. With ideal components, the duty cycle ratio is proportional to the ratio of the voltage of the low voltage battery 18 and the high voltage battery 16. In an embodiment with a 12V battery as a low voltage battery 18 and a 36V battery as a high voltage battery 16, the duty cycle of the control signal would be 1:3, i.e. the transistor is switched off three times longer than it is switched on. Thus, the current I₁ that is discharged from battery 16 in the switch-on phase would be converted to a three times higher charging current I_{L}. In reality, due to non-ideal electrical components, however, a conversion efficiency of close to 96% can be achieved.

FIG. 4A is a schematic of a battery system 200 which, largely, comprises the same electrical elements as in FIG. 3A. Therefore, the same reference signs have been used in FIG. 4A for the same electrical elements that have already been presented in FIG. 3A. In addition to the function of the energy balancing device 15 to shift charges from the high voltage battery 16 to the low voltage battery 18, the energy balancing device 15 of FIG. 4A comprises a second transistor 157 which replaces the diode 154 of the embodiment shown in FIG. 3A and allows the energy balancing device 15 to shift charges from the low voltage battery 18 to the high voltage battery 16. The collector C2 of this second transistor 157 is connected to the floating terminal 151 of the conductor 150 and the emitter E2 of the second transistor 157 is connected to the common ground rail 14. As the voltage U_{L} generated by the self-induction of the inductor 150 may reach values which could destroy the collector emitter path C1-E1 of the first transistor 153 or the collector emitter path C2-E2 of the second transistor 157, respectively, the collector emitter path of the first transistor 153 and the second transistor 157 each are protected by a free-wheeling diode 158, 159. A further smoothing capacitor 156 connects the high voltage rail 13 and the fixed terminal of the inductor 150.

The equivalent simplified diagram of FIG. 4B shows the same situation as the equivalent simplified diagram of FIG. 3B. In this static state, the controller 11 produces control signals which set the first transistor 153 and the second transistor 157 both in a non-conductive state. This is symbolised in FIG. 4B by an open connection between the collector C1 of the first transistor 153 and the emitter E1 of the first transistor 153 and another open connection between the collector C2 of the second transistor 157 and the emitter E2 of the second transistor 157. After some time, in this static state, the electromagnetic field of the inductor 150 has collapsed, if there was any to begin with, the voltage at the floating terminal 151 of the inductor 150 is the same as the voltage of the positive pole of the low voltage battery 18.

FIG. 4C shows the same situation as already described in FIG. 3C. When the controller 11 is switched into the mode to transfer charges from the high voltage battery 16 to the low voltage battery 18 in a first phase of this transfer process, the controller switches the first transistor 153 into a conductive state and keeps, at the same time, the second transistor 157 in a non-conductive state. This means that a current I₁ flows from the high voltage rail 13 through the inductor 150 and builds up an electromagnetic field around the inductor 150. In a second phase, the controller 11 then sets the first transistor 153 into a non-conductive state and the second transistor 157 into a conductive state. In this situation, as shown in FIG. 4D, and already explained in FIG. 3D, the electromagnetic field of the inductor 150 collapses and creates a self-induced voltage U_{L} in order to resist to a change of the direction of the current I₁. As the floating terminal 151 of the inductor 150 is now connected over the closed connector-emitter path C2-E2 with the negative pole of the low voltage battery 18, the inductor 150 becomes a current source, once the induced voltage U_{L} has reached the voltage of the low voltage battery 18. This causes an induced current I_{L} to flow back to the floating terminal 151 of inductor 150 through the positive pole of low voltage battery 18, thus charging the low voltage battery 18. Practically, this is the same situation as depicted in FIG. 3D, apart from that, in that situation, the diode 154 automatically allowed the flow of the induced current I_{L}, now the controller 11 actively has to switch the second transistor 157 into a conductive state. As mentioned in connection with FIGS. 3C and 3D, at the end of the second phase, the controller 11 switches back the first transistor 153 and the second transistor 157 to the state as described in FIG. 4C and starts a new cycle.

FIG. 4E and FIG. 4F now show the cycle for transferring charges from the low voltage battery 18 to the high voltage battery 16. For ease of reference, in the following this transfer mode is called the ‘up-charge’ mode. In the first phase of the up-charge mode, the controller 11 sets the second transistor 157 in conductive state and the first transistor 153 in non-conductive state. As FIG. 4E shows, the collector emitter path C2-E2 of the second transistor 157 connects the floating terminal 151 of inductor 150 to the common rail 14. Thus, there is a closed circuit between the positive pole of low voltage battery 18, the conductor 150, and the negative pole of low voltage battery 18 allowing a current I₂ to flow. The inductor 150 creates an electromagnetic field in its surroundings, thus storing electromagnetic energy. At the end of the first period of the up-charge mode, the controller 11 reverses the switching states of the first transistor 153 and the second transistor 157. The situation of the second phase of the up charge mode is shown in FIG. 4F. The current flow from the positive pole of low voltage battery 18 through the inductor 150 is seized, as the collector emitter path C2-E2 is interrupted, i.e. in non-conductive state. In order to resist to a change of direction of the current I_{L} flowing through the inductor 150, the collapsing electromagnetic field of inductor 150 induces a voltage U_{L} and renders the inductor 150 into a current source, creating an induced current I_{L} which flows through the closed collector emitter path C1-E1 of the first transistor 153 into the positive pole of the high voltage battery 16 and back to the fixed terminal of the inductor 150, thus charging the high voltage battery 16. As already mentioned for the down-charging mode, the inverter 12 may continue to produce a charging current I_{charge} that in addition to the charge transfer from the low voltage battery 18 to the high voltage battery 16 charges both batteries, the high voltage battery 16 and the low voltage battery 18.

After the end of this second phase of the up-charge mode, the controller reverses again, the switching stage of the first transistor 153 and the second transistor 157 to start a new cycle. Again, in this mode, duty cycle of the control signals for the first transistor 153 and the second transistor 157 and the switching frequency will eventually determine the efficiency of the charge transfer. With a nominal voltage of the low voltage battery 18 of 12V and a nominal voltage of the high voltage battery 16 of 36V, the duty cycle for the control signal to control the switching state of the second transistor 157 will be ideally 3:1, i.e. the first transistor 153 is switched on 3 times longer than switched off. For the person skilled in the art, it is apparent that whether the energy balancing device is in down-charge mode or is in up-charge mode depends primarily on the duty cycle. By adjusting the duty cycle, the energy balancing device can react to voltages which deviate from the nominal voltage of the low voltage battery 18 and the high voltage battery 16. For the purpose of adapting the duty cycle accordingly, the controller 11 monitors the level of the low voltage battery 18 and the voltage of the low voltage battery 18 and the charging level of the high voltage battery 16 and the voltage of the high voltage battery 16. In accordance with the measured values, the controller 11 may fine tune the duty cycle for the control signals of the first transistor 153 and the second transistor 157.

Whilst the battery systems 100, 200 described with respect to FIGS. 3A to 4F have an energy balancing device 15 with a number of components 153, 150, 154, 155 (in respect of the embodiment of FIGS. 3A to 3D) and additionally components 156, 157, 158, 159 (in respect of the embodiment of FIGS. 4A to 4F), alternatively the energy balancing device 15 has different components that are used to implement the same effect. Alternatively, or additionally, the battery systems 100, 200 can include further components that are used to enhance or supplement the effect of the battery systems 100, 200.

Whilst the controller 11 is shown at FIG. 1 to be distinct from the energy balancing device 15, alternatively, the energy balancing device 15 and the controller 11 are integrated and form a single energy balancing device.

Whilst the switching elements 153, 157 are transistor switches 153, 157, alternatively, the switching mechanism may be implemented using any switching element. The switching elements are controlled by controller 11. Alternatively, the switching elements are controlled by any appropriate controller. The controller monitors properties of the battery systems 100, 200, such as the charge level in each of the 36 V leg 16 and the 12 V leg 18. The controller 11 processes the information relating to the properties of the battery systems 100, 200 that it monitors and controls the switching elements based on the properties. The controller 11 processes the information relating to the properties of the battery systems 100, 200 at the processor 11A of the controller 11. Alternatively, the controller 11 monitors other properties of the battery systems 100, 200, such as applied load, and controls the transistors 153, 157 according to control algorithms maintained in the memory 11B of the controller 11. Whilst pulse width modulated signals are applied to the transistors 153, 157 using software stored in the memory 11B of the controller 11 to control the ratio of time with which the transistors 153, 157 are in the on and off states, alternatively, the transistors 153, 157 are controlled using control schemes formed in hardware.

Control of the transistors 153, 157 by switching the transistors 153, 157 on and off enables the voltage sourced from the 12V battery leg 18 to be boosted in line with the voltage of the 36 V battery leg 16 of the battery 19. Accordingly, the 36 V battery leg 16 is charged from the 12 V battery leg 18 and charge is transferred within the battery 19. Whilst the battery system 200, as described at FIGS. 4E and 4F shows the connection to the motor/generator 10 via the 48 V inverter 12, the motor/generator 10 is selectively turned on or off, depending on the requirements of the battery system 200. A controller, such as controller 11 described with reference to FIG. 1, can be used to monitor the properties of the battery system 200 in order to determine how the transistors 153, 157 are operated. For example, the controller 11 controls the transistors 153, 157, so that the system charges up or discharges the 36 V battery leg 16 and/or the 12 V battery leg 18 based on charging algorithms, or CO₂ control algorithms.

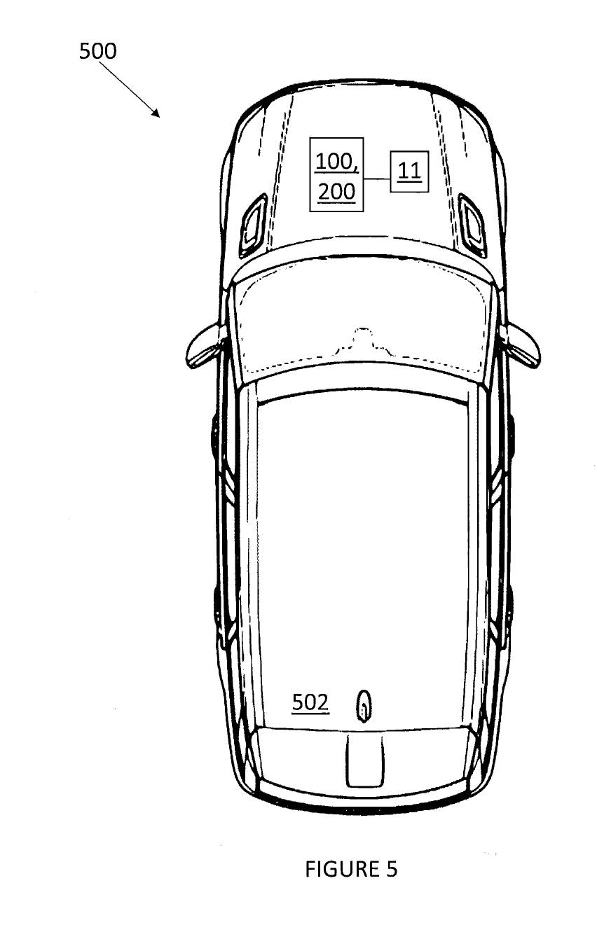

Beneficially, the battery systems 100, 200, including controllers, such as controller 11 described with reference to FIG. 1, can be integrated into vehicles, such as hybrid electric vehicles. FIG. 5 shows a vehicle system 500. The vehicle system 500 is a vehicle 502 having a battery system 100, 200 and a controller 11. The battery system 100, 200, provides electric sources to service loads of different voltages. Advantageously, the battery system 100, 200 provides loads at 12 V and 48 V, providing drive support along for a hybrid electric vehicle, along with the power to service the numerous electric systems found in a vehicle 502.

Advantageously, the battery systems 100, 200, described above with reference to FIGS. 1 to 5 provide a single battery that can intelligently redistribute the apportionment of charge between different battery legs with different nominal voltages and capacities. Beneficially, the use of a single converter enables switching between up-conversion and down-conversion and therefore the battery system 100, 200 provides a simple and elegant mechanism for efficiently converting voltages in order to enable the redistribution of charge in a battery.

Advantageously, compared with a standard 48 V battery, the high capacity 12 V battery is large and therefore heat dissipation is low and the battery system 100, 200 is simpler to cool than known systems. 12 V batteries are not subject to the same level heating as a standalone 48 V battery. Further, the efficient integration of a 12 V battery in series with a 36 V battery means that the battery system 100, 200 will have reduced weight and package volume than known systems that have separate 48 V and 12 V batteries that are typically required in hybrid electric vehicles.

Whilst the above battery systems 100, 200 are described with reference to a 36 V battery leg and a 12 V battery leg in series, alternatively the battery systems have different voltage battery legs in series. Further, whilst the batteries 19, 19 of the battery systems 100, 200 are each shown to have two legs 16 and 18 in the battery 19, alternatively, the battery 19 may have more than two legs in series.

Further, whilst the battery systems 100, 200 are describe with reference to a 12 V battery being a 120 Ah battery in a 4S3P configuration and the 36 V battery being an 8 Ah 10S1P battery, alternatively the battery legs of the batteries of the battery systems 100, 200 may have cells of different properties, including different storage capacities, arranged in different configurations.

The batteries 19, described with reference to the battery systems 100, 200 are Lithium ion batteries. However, alternatively, the batteries 19 of the battery systems 100, 200 are any type of rechargeable battery, for example, lead acid batteries.

Whilst the 48 V inverter 12 is used as described above, alternatively, an inverter of a different voltage is used to match the battery 19 of the battery system 100, 200 and the required load.

1. A battery system comprising:
a battery having a first leg connected in series with a second leg, wherein the first leg is configured to supply a first voltage and the second leg is configured to supply a second voltage and wherein the first voltage is different from the second voltage; and
an energy balancing device;
wherein:
the energy balancing device is arranged to:
monitor one or more properties of the first leg and/or second leg; and
control transfer of charge between the first leg and the second leg, thereby to adjust a level of charge of each of the first leg and the second leg based on the one or more monitored properties of the first leg and/or second leg.

2. The battery system of claim 1, wherein the energy balancing device comprises a voltage converter, wherein the voltage converter is configured to convert a voltage of the first leg substantially to a voltage of the second leg, thereby to enable transfer of charge from the first leg to the second leg.

3. The battery system of claim 2, wherein the voltage converter is configured to convert the voltage of the second leg substantially to the voltage of the first leg, thereby to enable transfer of charge from the second leg to the first leg.

4. The battery system of claim 1, wherein if the level of charge of the first leg is above a threshold level of charge of the first leg and the level of charge of the second leg is below a threshold level of charge of the second leg, the energy balancing device is arranged to adjust a level of charge of the battery by transferring stored energy from the first leg to the second leg.

5. The battery system of claim 1, wherein if the level of charge of the second leg is above a threshold level of charge and the second leg and the level of charge of the first leg is below a threshold level of charge of the first leg, the energy balancing device is arranged to adjust a level of charge of the battery by transferring stored energy from the second leg to the first leg.

6. The battery system of claim 1, wherein the energy balancing device comprises:
a switching element; and
an inductor, wherein the switching element and the inductor are in electrical communication with the first leg and the second leg, and wherein the energy balancing device is arranged to control the transfer of charge between the first leg and the second leg by operating the switching element so as to control a flow of current through the inductor.

7. The battery system of claim 6, wherein the inductor is arranged electrically to connect to a common terminal of the first leg and of the second leg, and wherein the switching element is arranged electrically selectively to connect a positive terminal of the battery with the inductor.

8. The battery system of claim 6, wherein a pulse width modulated signal is applied to the switching element.

9. The battery system of claim 6, wherein the energy balancing device comprises a circuit blocking element arranged to prevent flow of current from the switching element to a negative terminal of the battery.

10. The battery system of claim 6, wherein the energy balancing device comprises a further switching element in electrical communication with the first leg and the second leg, wherein the energy balancing device is arranged to control the transfer of charge between the first leg and the second leg by operating both the switching element and the further switching element so as to control the flow of current through the inductor.

11. The battery system of claim 10, wherein the switching element and/or further switching element are in parallel with circuit blocking elements.

12. The battery system of claim 1, wherein the first voltage is higher than the second voltage.

13. The battery system of claim 1, wherein the first leg has a first energy storage capacity and the second leg has a second energy storage capacity, wherein the first energy storage capacity is different from the second energy storage capacity.

14. The battery system of claim 1, wherein the battery system is arranged selectively to receive power from a power source, thereby to recharge the first leg and/or the second leg.

15. The battery system of claim 1, wherein the first leg is a 36 V battery and/or the second leg is a 12 V battery.

16. The battery system according to claim 1, wherein the battery system is in communication with a motor and/or a generator.

17. The battery system of claim 1, wherein the battery system is configured to drive a starter motor.

18. The battery system of claim 1, wherein the first leg and the second leg are integrated into a single unit.

19. A method of adjusting the state of charge in a battery system comprising a battery having a first leg connected in series with a second leg, wherein the first leg is configured to supply a first voltage and the second leg is configured to supply a second voltage and wherein the first voltage is different from the second voltage, the method comprising:
monitoring one or more properties of the first leg and/or second leg; and
in dependence on the one or more monitored properties:
controlling transfer of charge between the first leg and the second leg, thereby to adjust a state of charge of each of the first leg and the second leg.

20. A vehicle comprising a battery system according to claim 1.
